(19) United States
(12) Patent Application Publication
(10) Pub. No.: US 2018/0120255 A1
(43) Pub. Date: May 3, 2018

(54) LIGHT INDUCED DIELECTROPHORESIS (LIDEP) DEVICE

(71) Applicant: TECHTRON TECHNOLOGY CO., LTD., NEW TAIPEI CITY (TW)

(72) Inventors: Hung-Wei WU, TAINAN CITY (TW); Cheng-Yuan HUNG, KAOHSIUNG CITY (TW); Chang-Sin YE, TAINAN CITY (TW)

(21) Appl. No.: 15/657,202

(22) Filed: Jul. 23, 2017

(30) Foreign Application Priority Data
Oct. 27, 2016 (TW) 105134720

(51) Int. Cl. G01N 27/447; B03C 5/00; B03C 5/02

(52) U.S. Cl. CPC G01N 27/447; B03C 5/005; B03C 2201/26; B03C 5/026; B03C 5/024

(57) ABSTRACT

A light induced dielectrophoresis (LIDEP) device is configured to perform a sorting process on a liquid including plural first micro-particles and plural second micro-particles. The LIDEP device includes a LIDEP chip and an opaque cartridge. The LIDEP chip includes a first electrode layer, a second electrode layer, a semiconductor layer, and a flow channel layer. The flow channel layer defines a first channel, a second channel and a third channel intersected at a confluence. The first channel is configured to guide the liquid. The flow channel layer further defines a projection region including the confluence. A patterned light source is projected on the projection region, thereby guiding the first micro-particles and the second micro-particles located within the confluence to move toward the second channel and the third channel, respectively. The opaque cartridge covers the LIDEP chip and has an opening. The vertical projection of the opening overlaps the projection region.

### RELATED APPLICATIONS

This application claims priority to Taiwan Patent Application Serial Number 105134720, filed on Oct. 27, 2016, which is herein incorporated by reference.

### BACKGROUND

### Field of Invention

The present invention relates to a light induced dielectrophoresis (LIDEP) device. More particularly, the present invention relates to a LIDEP device configured to perform a sorting process on a liquid including different micro-particles by a LIDEP force.

### Description of Related Art

Medical diagnosis uses various medical analysis instruments to analyze several kinds of the micro-particles and then uses the analysis results to assist in evaluating the physiological status of the biological body. If only one kind of the micro-particles need to be analyzed, a sorting process needs to be performed on the liquid including different kinds of the micro-particles. However, if the sorting results are not good, the subsequent analysis instruments will be seriously affected, thereby reducing the accuracy of the analysis results of the subsequent analysis instruments.

In view of this, a control technology using the LIDEP force to drive a phoresis of the micro-particles has been studied extensively. The control technology needs to be performed on a chip including a photoconductive material. A method of the control technology is to project an optical pattern on the chip, thereby generating the LIDEP force to drive the phoresis of the micro-particles. The control technology can simplify the complicated process of the pretreatment of the biologic samples.

### SUMMARY

An objective of the invention is to provide a LIDEP device configured to perform a sorting process on a liquid including different kinds of the micro-particles, thereby benefiting the subsequent analysis instruments to analyze the micro-particles.

One aspect of the invention is directed to a LIDEP device configured to perform a sorting process on a liquid including plural first micro-particles and plural second micro-particles. The LIDEP device includes a LIDEP chip and an opaque cartridge. The LIDEP chip includes a first electrode layer, a second electrode layer, a semiconductor layer, and a flow channel layer. The second electrode layer is disposed opposite to the first electrode layer. The semiconductor layer is disposed on the first electrode layer. The flow channel layer is disposed between the second electrode layer and the semiconductor layer. The flow channel layer defines a first channel, a second channel and a third channel intersected at a confluence. The first channel, the second channel and the third channel are configured to guide the liquid, the first micro-particles and the second micro-particles, respectively. The flow channel layer further defines a projection region including the confluence. A patterned light source is projected on the projection region, thereby changing an electric field generating between the first electrode layer and the second electrode layer. The electric filed is configured to guide the first micro-particles and the second micro-particles located within the confluence to move toward the second channel and the third channel, respectively. The opaque cartridge covers the LIDEP chip and has an opening. The vertical projection of the opening projected on the flow channel layer overlaps the projection region.

In accordance with some embodiments of the invention, the first electrode layer and the second electrode layer include a transparent conductive material.

In accordance with some embodiments of the invention, the semiconductor layer includes an indirect bandgap material, and a crystal structure of the semiconductor layer is an amorphous structure, a microcrystalline structure, a polycrystalline structure, or a single crystal structure.

In accordance with some embodiments of the invention, a thickness of the flow channel layer is between 30 μm and 150 μm, and a size of the projection region is between 1 mm×1 mm and 10 mm×10 mm.

In accordance with some embodiments of the invention, the flow channel layer further defines an injection opening, a first outflow opening and a second outflow opening, in which the liquid is injected into the first channel through the injection opening, and the first micro-particles flow out from the first outflow opening through the second channel, and the second micro-particles flow out from the second outflow opening through the third channel.

In accordance with some embodiments of the invention, the LIDEP chip further includes a first buffer layer and a second buffer layer, in which the first electrode layer is disposed on the first buffer layer, and the second buffer layer is disposed on the second electrode layer.

In accordance with some embodiments of the invention, the LIDEP chip further includes an upper substrate and a lower substrate, in which the upper substrate is disposed on the second buffer layer, and the first buffer layer is disposed on the lower substrate.

In accordance with some embodiments of the invention, the upper substrate is a transparent substrate, and the lower substrate is the transparent substrate.

In accordance with some embodiments of the invention, the first buffer layer is configured to enhance a lattice match between the first electrode layer and the lower substrate, and the second buffer layer is configured to enhance the lattice match between the second electrode layer and the upper substrate.

In accordance with some embodiments of the invention, the opaque cartridge has an injection inlet, a first outflow outlet, and a second outflow outlet, in which the injection inlet is configured to allow the liquid to be injected into the LIDEP chip, and the first outflow outlet is configured to allow the first micro-particles to flow out of the LIDEP chip, and the second outflow outlet is configured to allow the second micro-particles to flow out of the LIDEP chip.

### BRIEF DESCRIPTION OF THE DRAWINGS

The invention can be more fully understood by reading the following detailed description of the embodiment, with reference made to the accompanying drawings as follows:

FIG. 1A is a cross-sectional view of the LIDEP device according to an embodiment of the present invention.

FIG. 1B is a bottom view of the LIDEP device according to the embodiment of the present invention.

FIG. 2 is a plan view of a flow channel layer of a LIDEP chip according to the embodiment of the present invention.

FIGS. 3A-3G are schematic views of several patterns of a patterned light according to the embodiment of the present invention.

FIG. 4A is a schematic view of an electric field distribution of the LIDEP chip according to the embodiment of the present invention, in which the LIEDP chip is not projected by the patterned light.

FIG. 4B is a schematic view of the electric field distribution of the LIDEP chip projected by the patterned light according to the embodiment of the present invention.

FIG. 5A is a schematic view of a distribution of the first micro-particles and the second micro-particles of the LIDEP chip according to the embodiment of the present invention, in which the LIEDP chip is not projected by the patterned light.

FIG. 5B is a schematic view of the distribution of the first micro-particles and the second micro-particles of the LIDEP chip projected by the patterned light according to the embodiment of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

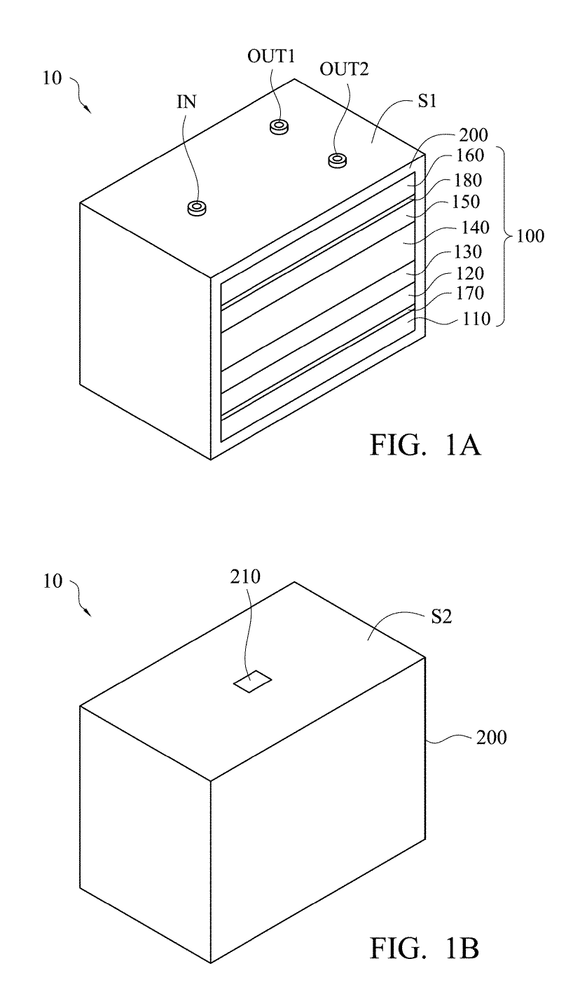

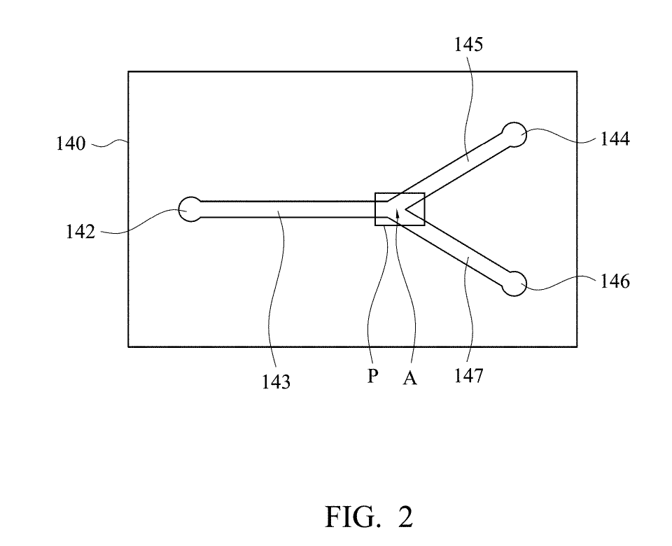

FIG. 1A is a cross-sectional view of the LIDEP device 10 according to an embodiment of the present invention. The LIDEP device 10 includes a LIDEP chip 100 and an opaque cartridge 200. The LIDEP chip 100 includes a lower substrate 110, a first electrode layer 120, a semiconductor layer 130, a flow channel layer 140, a second electrode layer 150, and an upper substrate 160. The lower substrate 110 is a transparent substrate which is permeable to light, such as a glass substrate or a plastic substrate, but embodiments of the present invention are not limited thereto.

The first electrode layer 120 is disposed on the lower substrate 110. The first electrode layer 120 includes a transparent conductive material, such as indium tin oxide (ITO), indium zinc oxide (IZO), or other similar conductive materials.

The second electrode layer 150 is disposed on the flow channel layer 140. The second electrode layer 150 includes a transparent conductive material, such as indium tin oxide (ITO), indium zinc oxide (IZO), or other similar conductive materials. The upper substrate 160 is disposed on the second electrode layer 150. The upper substrate 160 is the transparent substrate which is permeable to light, such as the glass substrate or the plastic substrate, but embodiments of the present invention are not limited thereto.

The semiconductor layer 130 is disposed on the first electrode layer 120. The semiconductor layer 130 includes an indirect bandgap material, such as silicon, germanium, or other similar materials. A crystal structure of the semiconductor layer 130 is an amorphous structure, a microcrystalline structure, a polycrystalline structure, or a single crystal structure.

The LIDEP chip 100 is configured to perform a sorting process on a liquid including different kinds of the micro-particles. In some embodiments of the present invention, the micro-particles can be the biological cells, the air particles, the impurities in water or the dielectric powders. After the liquid including plural first micro-particles and plural second micro-particles is injected into the LIDEP chip, when a light source is projected on the LIDEP chip, a distribution of an internal electric field of the LIDEP chip 100 changes due to an effect of the light source. Then, different dielectrophoresis (DEP) forces act on the first micro-particles and the second micro-particles, such that the first micro-particles and the second micro-particles move to different positions. Therefore, the first micro-particles and the second micro-particles in the liquid which is injected into the LIDEP chip 100 can be sorted.

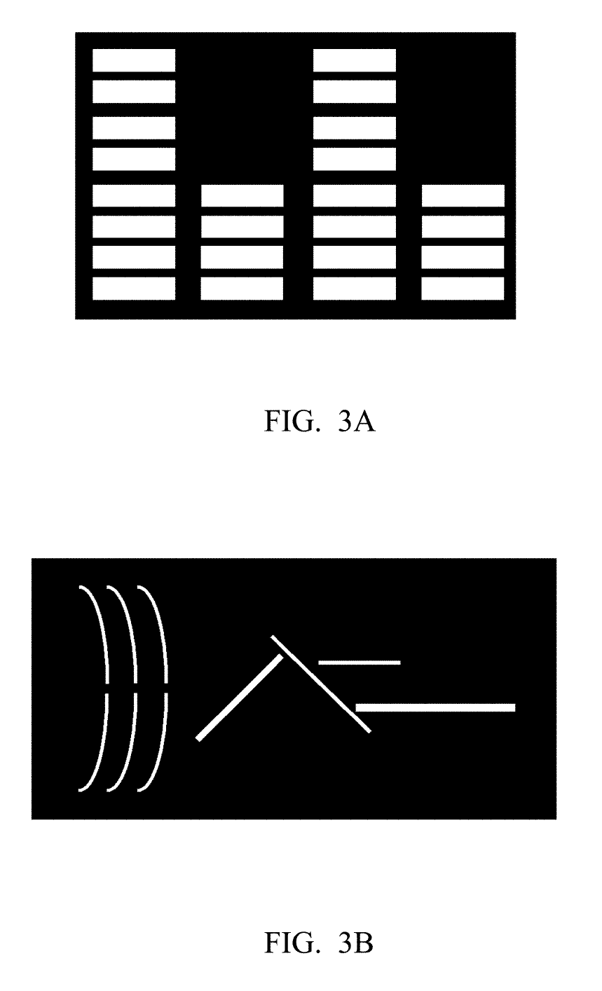

The flow channel layer 140 is disposed on the semiconductor layer 130. Referring to FIG. 1 and FIG. 2, FIG. 2 is a plan view of the flow channel layer 140 of the LIDEP chip 100 according to the embodiment of the present invention. The flow channel layer 140 defines an injection opening 142, a first outflow opening 144, a second outflow opening 146, a first channel 143, a second channel 145 and a third channel 147. The first channel 143, the second channel 145 and the third channel 147 are intersected at a confluence A. The liquid is injected into the flow channel layer 140 through the injection opening 142. The first channel 143 is configured to guide the liquid to flow toward the confluence A. If the first micro-particles and the second micro-particles in the liquid within the confluence A are affected by the change of the internal electric field, the first micro-particles and the second micro-particles move toward different directions, thereby guiding the first micro-particle to move in a direction from the confluence A toward the second channel 145 and guiding the second micro-particle to move in a direction from the confluence A toward the third channel 147. Thus, when the liquid is continually injected into the flow channel layer 140 through the injection opening 142, the second channel 145 can guide the first micro-particles to flow out of the LIDEP chip 100 through the first outflow opening 144, and the third channel 147 can guide the second micro-particles to flow out of the LIDEP chip 100 through the second outflow opening 146.

Referring to FIG. 1, the opaque cartridge 200 is located at the outer portion of the LIDEP chip to cover the LIDEP chip 100. In addition, a top surface S1 of the opaque cartridge 200 has an injection inlet IN, a first outflow outlet OUT1, and a second outflow outlet OUT2. The injection inlet IN is configured to allow the liquid to be injected into the LIDEP chip 100 through the injection opening 142. The first outflow outlet OUT1 is configured to allow the first micro-particles to flow out of the LIDEP chip 100 through the first outflow opening 144. The second outflow outlet OUT2 is configured to allow the second micro-particles to flow out of the LIDEP chip 100 through the second outflow opening 146. It is noted that the positions of the vertical projections of the injection inlet IN, the first outflow outlet OUT1, and the second outflow outlet OUT2 of the opaque cartridge 200 match the positions of the injection opening 142, the first outflow opening 144, and the second outflow opening 146, respectively.

Referring to FIG. 2, the flow channel layer 140 further defines a projection region P. A patterned light source is projected on the projection region P. The projection region P includes the confluence A. In some embodiments of the present invention, a size of the projection region is 1.5 mm×1.5 mm, but embodiments of the present invention are not limited thereto.

FIG. 1B is a bottom view of the LIDEP device 10 according to the embodiment of the present invention. A bottom surface S2 of the opaque cartridge 200 has an opening 210. The vertical projection of the opening 210 on the flow channel layer 140 overlaps the projection region P. Therefore, the patterned light source can be projected on the projection region P of the flow channel layer 140 through the opening 210. It is noted that the opaque cartridge 200 is made of an opaque material. Thus, other light sources which may cause interference are blocked from the LIDEP chip 100 except for the patterned light source projected into the LIDEP chip 100 through the opening 210.

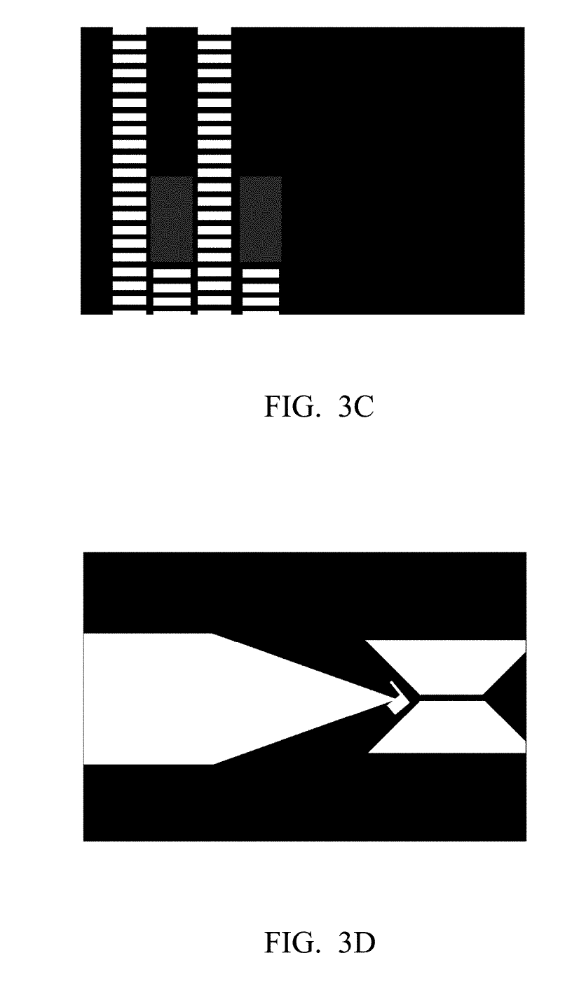

It is noted that a pattern of the patterned light source may change. The pattern of the patterned light source is compatible with the LIDEP chip 100, such that the first micro-particles and the second micro-particles in the liquid of the LIDEP chip 100 can be sorted. FIGS. 3A-3G are schematic views of several patterns of the patterned light according to the embodiment of the present invention. The patterns as shown in FIGS. 3A-3G include a ladder pattern, a scissor pattern, a combined pattern, a T&S pattern, and an induced pattern. It is noted that the patterns as shown in FIGS. 3A-3G are exemplary. In actual operation, the pattern of the patterned light source may change according to several operation factors, such as a combination of the first micro-particles and the second micro-particles or a structure of the flow channel layer 140 of the LIDEP chip 100. In other words, the patterns of the patterned light source are not limited to the patterns as shown in FIGS. 3A-3G.

In some embodiments of the present invention, a thickness of the lower substrate 110 and the upper substrate 160 is about 0.7 mm. The thickness of the first electrode layer 120 and the second electrode layer 150 is between 50 nm and 500 nm. The thickness of the semiconductor layer 130 is between 1 μm and 2 μm, preferably 1.2 μm. The thickness of the flow channel layer 140 is between 30 μm and 150 μm, preferably 50 μm. In addition, in some embodiments of the present invention, an included angle between the first channel 143 and the second channel 145 is about 169 degrees. The included angle between the second channel 145 and the third channel 147 is about 22 degrees. A width of the first channel 143, the second channel 145, and the third channel 147 is between 800 μm and 1000 μm. The diameter of the injection opening 142, the first outflow opening 144, and the second outflow opening 146 is about 1.1 mm. The size of the projection region P is between 1 mm×1 mm and 10 mm×10 mm, preferably 1.5 mm×1.5 mm. It is noted that the thicknesses, the widths, and the included angles of the components of the LIDEP chip 100 may adjust according to the actual demand and are not limited to aforementioned values.

Referring to FIG. 1A, the LIDEP chip 100 further includes the first buffer layer 170 and the second buffer layer 180. The first buffer layer 170 is disposed between the first electrode layer 120 and the lower substrate 110. The second buffer layer 180 is disposed between the second electrode layer 150 and the upper substrate 160. The first buffer layer 170 is configured to enhance a lattice match between the first electrode layer 120 and the lower substrate 110. The second buffer layer 180 is configured to enhance the lattice match between the second electrode layer 150 and the upper substrate 160. In other words, the first buffer layer 170 is configured to allow the first electrode layer 120 be more preferably attached on the lower substrate 110, and the second buffer layer 180 is configured to allow the second electrode layer 150 be more preferably attached below the upper substrate 160.

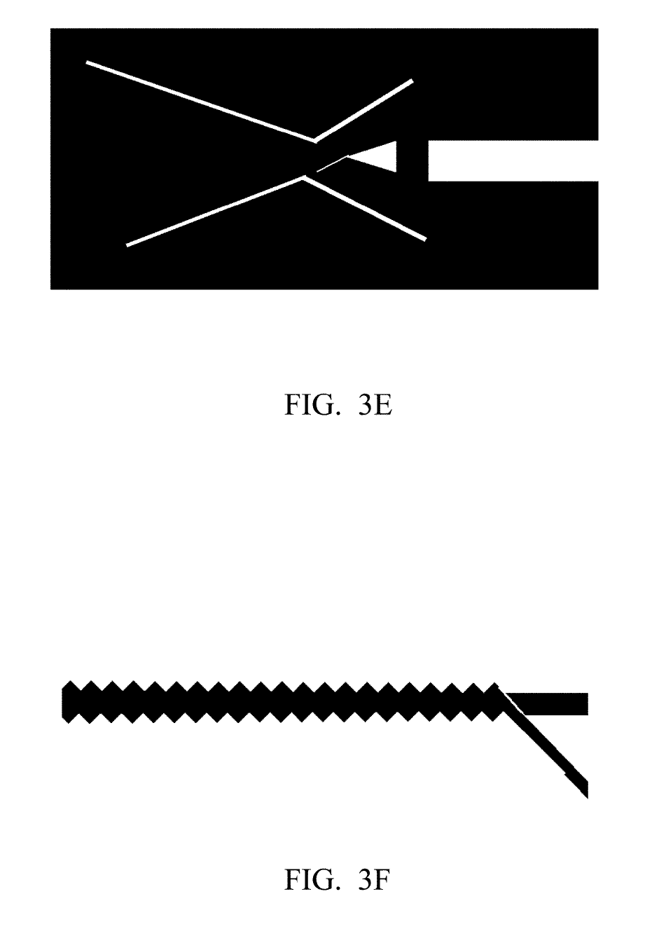

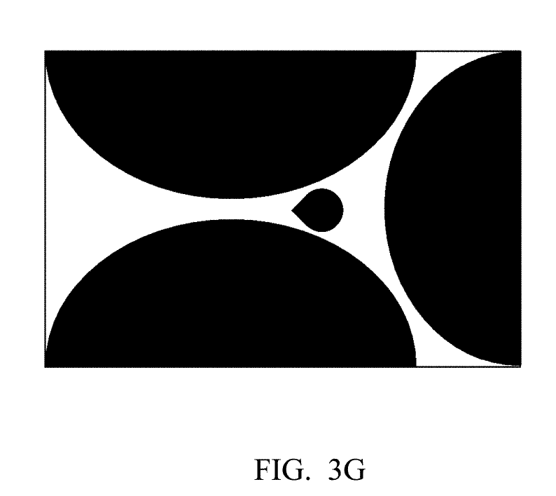

FIG. 4A is a schematic view of an electric field distribution of the LIDEP chip 100 according to the embodiment of the present invention, in which the LIEDP chip 100 is not projected by the patterned light. FIG. 4B is a schematic view of the electric field distribution of the LIDEP chip 100 projected by the patterned light according to the embodiment of the present invention. As shown in FIG. 4A, the first electrode layer 120 and the second electrode layer 150 are electrically connected to a power source AC, such that an electric field exists between the first electrode layer 120 and the second electrode layer 150. In some embodiments of the present invention, the power source AC provides an AC voltage, in which a peak-to-peak value of the AC voltage is between 1 volt and 50 volt, preferably between 15 volt and 25 volt. A frequency of the AC voltage is between 1 kHz and 100 MHz, preferably between 100 kHz and 1 MHz. However, embodiments of the present invention are not limited thereto. If the patterned light source is not projected on the LIDEP chip 100, as shown in FIG. 4A, the electric field between the first electrode layer 120 and the second electrode layer 150 is a uniform electric field. Thus, the first micro-particles C1 and the second micro-particles C2 do not move toward the specific direction. On the other hand, if the patterned light source is projected on the LIDEP chip 100, as shown in FIG. 4B, the distribution of the electric field between the first electrode layer 120 and the second electrode layer 150 is changed. Thus, the first micro-particles C1 are affected by the positive dielectrophoresis (DEP) force D1, thereby moving toward a projection position of the patterned light source, and the second micro-particles C2 are affected by the negative DEP force D2, thereby moving outside the projection position of the patterned light source.

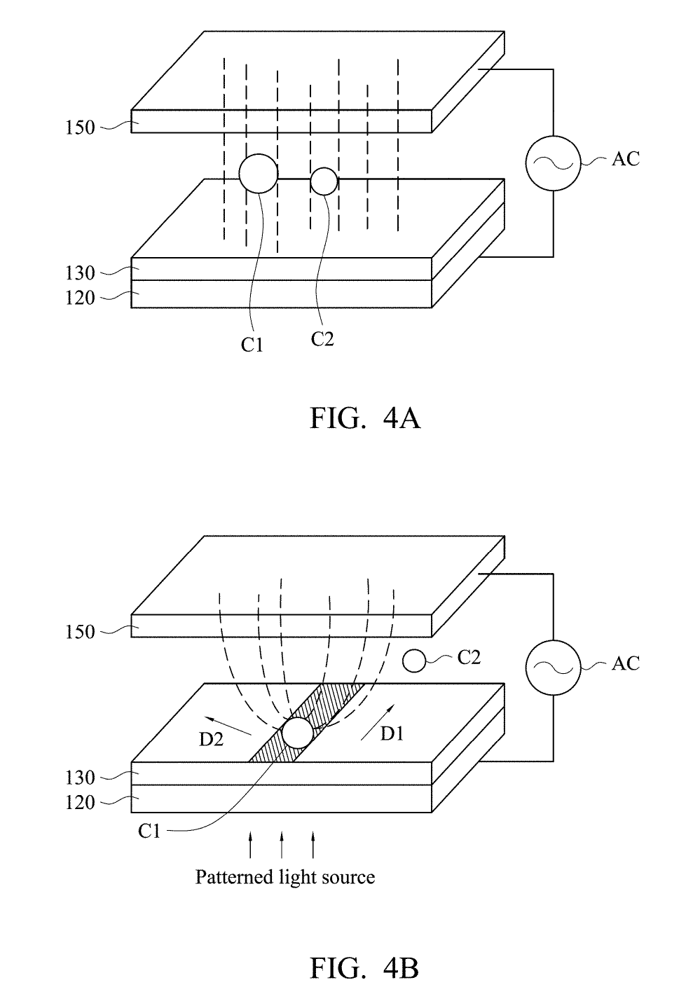

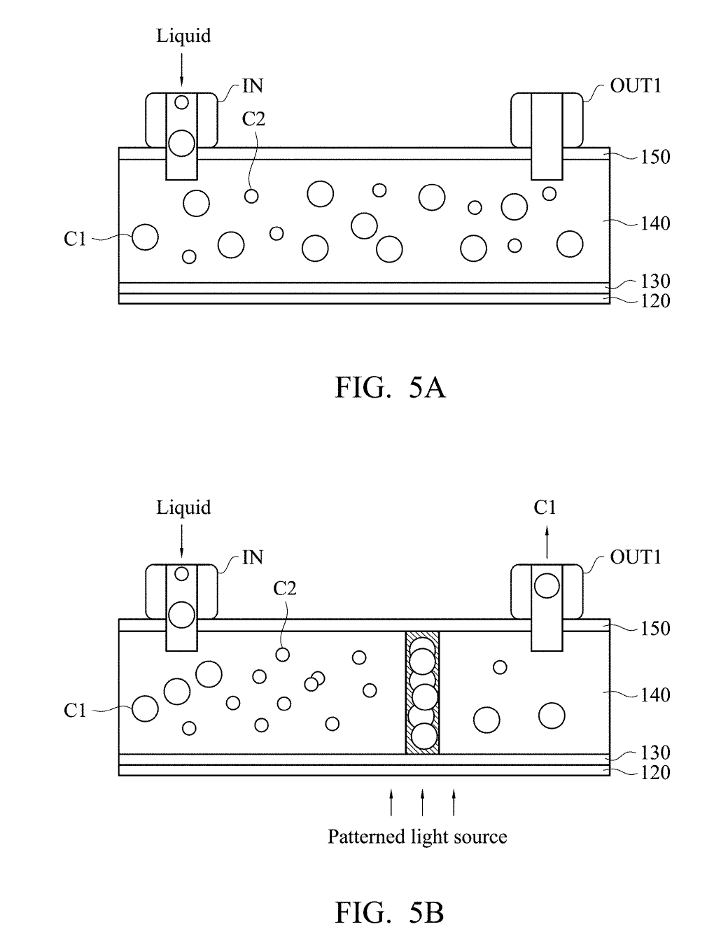

A sorting of the white blood cells and the cancer cells as an example, in which the cancer cells may include the colorectal cancer cells, the lung cancer cells, and the breast cancer cells. Referring to FIG. 5A and FIG. 5B, FIG. 5A is a schematic view of a distribution of the first micro-particles C1 and the second micro-particles C2 of the LIDEP chip 100 according to the embodiment of the present invention, in which the LIEDP chip 100 is not projected by the patterned light, and FIG. 5B is the schematic view of the distribution of the first micro-particles C1 and the second micro-particles C2 of the LIDEP chip 100 projected by the patterned light according to the embodiment of the present invention. The liquid includes the first micro-particles (such as the cancer cells) and the second micro-particles (such as the white blood cells). The liquid is injected into the flow channel layer 140 through the injection inlet IN. For the convenience of explanation, the upper substrate 110 and the lower substrate 160 are not drawn in FIG. 5A and FIG. 5B. If the patterned light source is not projected on the LIDEP chip 100, as shown in FIG. 5A, a distribution of the first micro-particles and the second micro-particles within the flow channel layer 140 is a uniform distribution. If the patterned light source is projected on the LIDEP chip 100, as shown in FIG. 5B, an electric field at a projection position of the patterned light source is stronger. Thus, the first micro-particles C1 are affected by the positive DEP force, thereby moving toward the projection position of the patterned light source, and the second micro-particles C2 are affected by the negative DEP force, thereby moving outside the projection position of the patterned light source. Therefore, the first micro-particles C1 move toward the first outflow outlet OUT1. When the liquid is continually injected into the flow channel layer 140 through the injection inlet IN, the first micro-particles C1 can flow out of the LIDEP chip 100 through the first outflow outlet OUT1.

In some embodiments of the present invention, the patterned light source can be continually changed, such that the first micro-particles and the second micro-particles can be more effective to move toward different directions, thereby optimizing the sorting results. In some embodiments of the present invention, the injection inlet of the LIDEP device can be connected to a pump, such that a user can adjust a flow rate of the liquid injected into the LIDEP chip, thereby optimizing the sorting result. For example, the flow rate is between 10 μL/min and 500 μL/min.

To sum up, the LIDEP device of the present invention can perform a sorting process to sort different kinds of the micro-particles in the liquid, thereby benefiting the subsequent analysis instruments to analyze the micro-particles.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light induced dielectrophoresis (LIDEP) device configured to perform a sorting process on a liquid including plural first micro-particles and plural second micro-particles, comprising:
a LIDEP chip comprises:
a first electrode layer;
a second electrode layer disposed opposite to the first electrode layer;
a semiconductor layer disposed on the first electrode layer, and
a flow channel layer disposed between the second electrode layer and the semiconductor layer;
wherein the flow channel layer defines a first channel, a second channel and a third channel intersected at a confluence;
wherein the first channel, the second channel and the third channel are configured to guide the liquid, the first micro-particles, and the second micro-particles, respectively;
wherein the flow channel layer further defines a projection region including the confluence;
wherein a patterned light source is projected on the projection region, thereby changing an electric field generating between the first electrode layer and the second electrode layer;
wherein the electric field is configured to guide the first micro-particles and the second micro-particles located within the confluence to move toward the second channel and the third channel, respectively; and
an opaque cartridge covering the LIDEP chip, wherein the opaque cartridge has an opening, and a vertical projection of the opening projected on the flow channel layer overlaps the projection region.

2. The LIDEP device of claim 1,
wherein the first electrode layer and the second electrode layer include a transparent conductive material.

3. The LIDEP device of claim 1,
wherein the semiconductor layer includes an indirect bandgap material, and a crystal structure of the semiconductor layer is an amorphous structure, a microcrystalline structure, a polycrystalline structure, or a single crystal structure.

4. The LIDEP device of claim 1,
wherein a thickness of the flow channel layer is between 30 μm and 150 μm; and
wherein a size of the projection region is between 1 mm×1 mm and 10 mm×10 mm.

5. The LIDEP device of claim 1,
wherein the flow channel layer further defines an injection opening, a first outflow opening, and a second outflow opening;
wherein the liquid is injected into the first flow channel through the injection opening;
wherein the first micro-particles flow out from the first outflow opening through the second channel; and
wherein the second micro-particle flow out from the second outflow opening through the third channel.

6. The LIDEP device of claim 1, wherein the LIDEP chip further comprises:
a first buffer layer, wherein the first electrode layer is disposed on the first buffer layer; and
a second buffer layer disposed on the second electrode layer.

7. The LIDEP device of claim 6, wherein the LIDEP chip further comprises:
an upper substrate disposed on the second buffer layer; and
a lower substrate, wherein the first buffer layer is disposed on the lower substrate.

8. The LIDEP device of claim 7,
wherein the upper substrate is a transparent substrate; and
wherein the lower substrate is the transparent substrate.

9. The LIDEP device of claim 6,
wherein the first buffer layer is configured to enhance a lattice match between the first electrode layer and the lower substrate; and
wherein the second buffer layer is configured to enhance the lattice match between the second electrode layer and the upper substrate.

10. The LIDEP device of claim 1,
wherein the opaque cartridge has an injection inlet, a first outflow outlet, and a second outflow outlet;
wherein the injection inlet is configured to allow the liquid to be injected into the LIDEP chip;
wherein the first outflow outlet is configured to allow the first micro-particles to flow out of the LIDEP chip; and
wherein the second outflow outlet is configured to allow the second micro-particles to flow out of the LIDEP chip.
